(19) United States
(12) Patent Application Publication
(10) Pub. No.: US 2018/0161126 A1
(43) Pub. Date: Jun. 14, 2018

(54) Orthodontic Bonding Guide

(71) Applicant: American Orthodontics Corporation, Sheboygan, WI (US)

(72) Inventors: Michael Craig Marshall, Sheboygan Falls, WI (US); Eric W. Nimmer, Plymouth, WI (US)

(73) Assignee: AMERICAN ORTHODONTICS CORPORATION, Sheboygan, WI (US)

(21) Appl. No.: 14/570,829

(22) Filed: Dec. 15, 2014

Related U.S. Application Data
(60) Provisional application No. 61/916,459, filed on Dec. 16, 2013.

(51) Int. Cl. A61C 7/14; A61C 7/16

(52) U.S. Cl. CPC A61C 7/146; A61C 7/16

(57) ABSTRACT

An orthodontic guide tray includes a tray surface at least partially congruent with a tooth surface. The orthodontic guide tray includes at least one opening in the gingival direction. The at least one opening is configured to be larger than a pad of a bracket to be placed on a tooth. At least one registration feature extends from a first side interior the opening. The at least one registration features is configured to define a prescribed bracket placement.

### CROSS-REFERENCE TO RELATED APPLICATION

The present utility application relates to and claims priority to U.S. Provisional Patent Application Ser. No. 61/916,549 filed Dec. 16, 2013, which is herein incorporated in entirety.

### BACKGROUND

The present disclosure is related to the field of orthodontics. More specifically, the present disclosure is related to a guide for the placement of direct bonded brackets for orthodontic treatment.

Orthodontic treatments are typically employed to correct the positioning of a plurality of teeth in the patient's dentition. Orthodontic treatments are typically carried out by bonding brackets to the patient's teeth and securing an arch wire between the brackets to place corrective forces on the teeth of the patient. The brackets are typically bonded to the teeth with the use of an adhesive. Since the bonded brackets transfer the corrective forces from the arch wire to the teeth, it is important to bond the brackets to the patient's teeth in the correct positions such that the teeth are moved to the desired post-treatment positions.

In direct bonding, the orthodontist manually places each of the brackets on the teeth of the patient based upon the orthodontist's training and experience in bracket placement. Undoubtedly, it will be recognized that such a direct bonding approach may result in placement of brackets at less than an idealized position, which can result in less than optimal outcomes. Alternatively, indirect bonding approaches are available wherein a physical model of the patient's pre-treatment dentition is created and the brackets are releaseably secured to the physical model at the desired bracket placement locations. A tray is molded around the physical model and the placed brackets. After the material of the transfer tray sets, the transfer tray, otherwise known as an indirect bonding tray, incorporates the brackets and the try and brackets are removed from the physical model. Bonding material (e.g. adhesive or bonding cement is placed on the brackets in the transfer tray and the transfer tray is placed on the patient's teeth. This positions the brackets in the desired optimal positions at which the brackets are bonded to the teeth. After the bonding has set, and the tray is removed, leaving the brackets in the desired positions.

One downside to indirect bonding trays is that inherently in the bonding process extraneous bonding material placed on the side of the bracket that engages the tooth, or the pad, may necessarily exit past the bracket pad sides onto the face of the tooth not covered by the bracket pad, as the bracket is pressed into contact with the tooth. Since the indirect bonding tray surrounds the bracket and the tooth, access to the tooth and this extraneous bonding material is limited until the material is set and the tray is removed from the patient's teeth. This may make cleanup more complex and time consuming which leads to both patient and orthodontist dissatisfaction.

Therefore, embodiments of a guide tray that facilitates direct bonding placement of brackets on the teeth of patients can facilitate improved bracket placement as well as enable the cleanup of extraneous bonding cement before removal of the guide.

### BRIEF DESCRIPTION OF THE DRAWINGS

FIG. 1 depicts an exemplary embodiment of a portion of a guide tray.

FIG. 2 is a plan view of an exemplary embodiment of a guide tray.

FIG. 3 is a front view of an exemplary portion of an additional embodiment of a guide tray.

FIG. 4 is a cut away view taken along line 4-4 in FIG. 3.

FIG. 5 is a front view of an exemplary portion of an additional embodiment of a guide tray.

FIG. 6 is a cut away view taken along line 6-6 in FIG. 5.

FIG. 7 is a front view of an exemplary portion of an additional embodiment of a guide tray.

FIG. 8 is a cut away view taken along line 8-8 of FIG. 7.

FIG. 9 is a flow chart that depicts an exemplary embodiment of a method of manufacturing a guide tray.

### BRIEF DISCLOSURE

An exemplary embodiment of an orthodontic guide tray includes a tray surface which is at least partially congruent with a respective occlusal tooth surface. At least one opening is in a gingival direction. The at least one opening is configured to be larger that a pad of a bracket to be placed on a tooth through the opening. At least one registration feature extends from a first side of the tray surface interior opening. The at least one registration feature is configured to defined a prescribed bracket placement on the tooth. In another exemplary embodiment of an orthodontic guide tray, a tray surface is at least partially congruent with perspective occlusal, lingual, and labial tooth surfaces. A plurality of openings extends through a first side of the tray surface. Each opening of the plurality includes an occlusal side and generally opposed lateral sides. Each opening of the plurality openings opens in a gingival direction and it is configured to be larger than a pad of a bracket to be placed on a tooth through the opening. At least one registration features extends from a first side of the tray surface interior the opening. At least one registration feature is configured to define a prescribed bracket placement on a tooth.

In exemplary embodiments of the orthodontic guide tray include at least one occlusal registration feature that extends from the occlusal side interior the opening and at least one lateral registration feature that extends from one of the lateral sides interior the opening.

An exemplary embodiment of an orthodontic guide tray is made up of a plurality of tooth segments. Each of the tooth segments include an occlusal portion with a tray surface that corresponds to an occlusal surface of a tooth of a patient. The tooth segment includes a lingual portion with a ray surface corresponding to a lingual surface of the tooth and a labial portion with a tray surface corresponding to a labial surface of the tooth. An opening in the labial portion is defined by an occlusal side and generally opposed lateral sides. The opening is generally larger in a bracket pad of a bracket configured to be adhered to a tooth of a patient. At least one registration feature extends from at least one of the occlusal side and the lateral side. The at least one registration feature defines a previously determined bracket placement on a tooth.

An exemplary embodiment of an orthodontic system includes a plurality of brackets each configured to be secured at a predetermined location on a tooth of a patient. A guide tray includes a plurality of tooth segments. Each of the tooth segments includes an occlusal portion with an occlusal tray surface corresponding to an occlusal surface of a tooth of a patient. Each of the tooth segments also includes a lingual portion with a lingual tray surface corresponding to a lingual surface of the tooth and labial portion with a labial tray surface corresponding to a labial surface of the tooth. An opening in the labial portion is defined by an occlusal side and generally opposing lateral sides. The opening is generally larger than a bracket pad of a bracket of the plurality of brackets configured to be adhered to the tooth. At least one registration features extends from at least one of the occlusal side and the lateral side. The at least one registration feature defines the predetermined location on the tooth of the patient relative to the bracket to be secured at the predetermined location.

### DETAILED DISCLOSURE

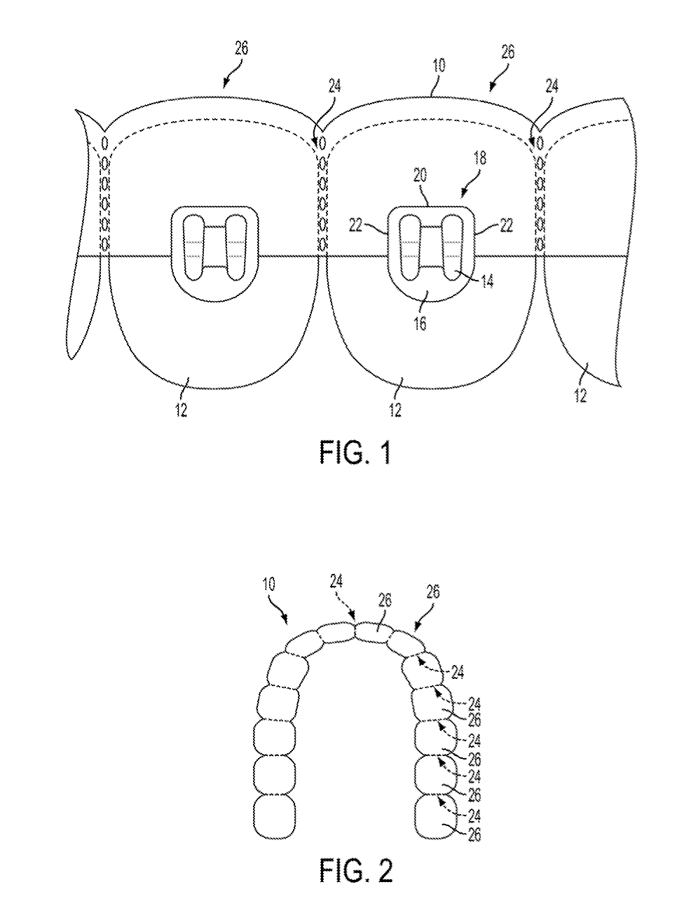

FIG. 1 depicts a partial view of an exemplary embodiment of a guide tray 10 as will be disclosed in further detail herein. The guide tray 10 is configured to conform to the shape of one or more teeth 12 of a patient's pre-treatment dentition. The guide tray 10 is used as disclosed herein to assist an orthodontist in placement of a plurality of brackets 14 secured to bracket pads 16, to the teeth 12 of the patient such as to apply orthodontic treatment. The bracket pad 16 is exemplarily shaped on a tooth engaging side to generally conform to the shape of the tooth 12. The pad 16 is secured to the surface of the tooth by bonding cement or adhesive. In embodiments, the bonding cement or adhesive may exemplarily be UV curing cement or adhesive, but may include other forms as will be recognized by a person of skill in the art.

The guide tray 10 further includes an opening 20 in the guide tray 10 that defines a desired placement of the bracket pad on the tooth of the patient. In an embodiment as will be described in further detail herein, the opening 18 may represent a desired bracket placement according to a known dimension of the bracket pad 16 to which the bracket 14 is secured and further in accordance with a prescription as requested by the orthodontist. Non-limiting embodiments of orthodontic prescriptions that may be used to determine the desired bracket placement may include Roth, MBT, or Andrews prescriptions. Such prescriptions are bracket placement philosophies, guides or heuristics which provide generalized guidance as to the proper bracket positioning on patient teeth to achieve a desired post-treatment alignment.

In an alternative embodiment, the orthodontist may positionally define desired bracket placements (e.g. 3 mm from the tooth cusp and 10° of tip angulation).

The opening 18 is defined by an occlusal side 20 and generally opposed lateral sides 22. The opening 18 is generally open outwardly from the surface of the tooth and open towards the gingival side of guide tray. In an exemplary embodiment, the guide tray 10 may be configured to facilitate either lingual or labial bracket placements, however, for the purposes of description, the present disclosure will focus on vestibular bracket placement, although it will be recognized that each of the same features as described herein may be similarly applied to a guide tray for lingual side bracket placement.

The opening 18 as defined by the occlusal side 20 and lateral sides 22 enables the definition of a desired bracket placement, including both linear and angular bracket position while promoting access by the orthodontist to place the bracket, and particularly the bracket pad 16, in registration with the occlusal side 20 and lateral sides 22 in order to fix the bracket in the desired position. In an embodiment, the occlusal side 20 and lateral sides 22 are configured to abut against the sides of the bracket pad 16 in two orthogonal dimensions to define the desired position of the bracket pad to which the associated bracket 14 is secured.

Embodiments of the guide tray 10 may further include a series of perforations 24 that separate the guide tray 10 into a plurality of tooth segments 26. FIG. 2 depicts a plan view of an embodiment of the guide tray 10 that depicts the tooth segments 26 separated by a separation feature, exemplarily perforations 24 in further detail. The separation feature may also include, but is not limited to, a groove or a localized area of reduced thickness. In embodiments, the guide tray 10 may be divided into a plurality of tooth segments either at the preference of the orthodontist to limit the number of teeth to which brackets are to be bonded at a time. In the event that a bracket must be replaced intra-treatment, a single tooth segment may be separated from the guide tray such that only the particular tooth segment of the guide tray required to replace the bracket for that specified tooth need be placed on the patient.

In other embodiment, tray segments for individual teeth, or for groups of teeth less than the entire tray may be constructed. In embodiments, the segments may releasably secure together to form a tray, including by friction engagement of respective tabs and slots on adjacent tray segments. Exemplary embodiments are further disclosed in co-pending U.S. patent application Ser. No. 14/199,343, which is hereby incorporated by reference in its entirety.

In embodiments, the guide tray 10 is constructed exemplarily using rapid prototyping, 3D printing, or CNC milling techniques as will be described in further detail herein. In such embodiments, the guide tray may be constructed such as to be releasably secured to the patient's dentition by a friction fit between the teeth and the guide tray while in an alternative embodiment an adhesive or the like may be applied to the interior of the guide tray to facilitate temporarily securing the guide tray to the patient's teeth. In exemplary embodiments as disclosed above wherein tray segments are separable or separation features exist between tray segments, these features may facilitate removal of trays after use by separation of tray segments, including bending or breaking along separation features, including perforations.

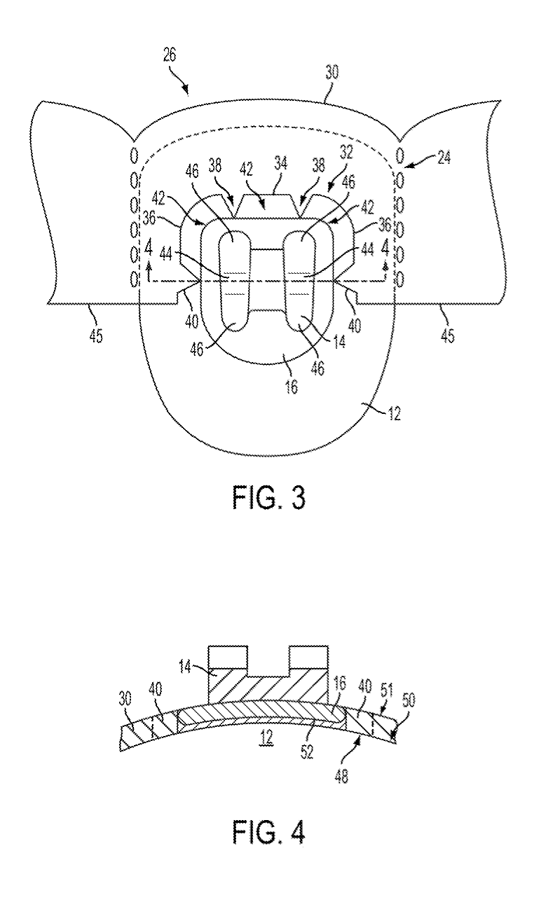

FIGS. 3 and 4 depict an alternative embodiment of a guide tray 30 as disclosed herein. For the purposes of consistency and conciseness, like reference numerals are used in the rest of the disclosure in order to reference like features between the embodiments, while focusing upon the features specific to that embodiment. The guide tray 30 includes an opening 32 that is configured to extend around the occlusal side 34 and lateral sides 36 of the bracket 14 and bracket pad 16. However, in the embodiment of the guide tray 30, the opening 32 is generally oversized, such that the opening 32 is larger than the bracket pad 16 and therefore, the occlusal side 34 and lateral sides 26 are spaced apart from the outer edges of the bracket pad 16. At least one occlusal registration feature 38 extends in the gingival direction from the occlusal side 34 and at least one lateral registration feature 40 extends into the opening 32 from at least one of the lateral sides 36. In the embodiment depicted in FIG. 3, the guide tray 30 includes two occlusal registration features 38 and two lateral registration features 40 for each opening 32. The registration features 38, 40 are configured such as to engage the bracket pad in such a manner as to define the desired bracket placement with respect to the tooth 12. Embodiments of the occlusal registration features 38 and the lateral registration features 40 are dimensioned such as to each define a specified registration position for the bracket pad 16, but to minimize contact with the bracket pad 16. As the opening 32 is generally larger than the bracket pad 16, a plurality of spaces 42 are formed between the occlusal and lateral registration features. In embodiments, any extraneous bonding cement or adhesive that pushes out from underneath the pad 16 is directed into the spaces 42 and therefore it may be cleaned up by a clinician prior to curing of the adhesive or cement and removal of the guide tray 30.

FIG. 4 is a partial cut away view taken along line 4-4 of FIG. 3. From the cut away view of FIG. 4, the tooth surface 48 and the tray surface 50 can be seen as congruent, as described above, in some embodiments, the guide tray 30 may secure to the patient's teeth 12 by a friction fit between the guide tray and the teeth due to the congruency of the tray surface 50 with the teeth surface 48. Additionally, as the registration features 38, 40 are configured to minimize contact with the bracket pad 16, the cement or adhesive 52 that pushes out from underneath the bracket pad is directed past the registration features 38, 40 into the spaces 42, rather than underneath the tray surface 50 between the tooth surface 48 and the tray surface 50.

In still further embodiments, one or more of the registration features 38, 40 may also indicate a visual alignment with one or more features of the bracket 14 or pad 16. As exemplarily shown in FIG. 3 the lateral registration features 40 visually align with the arch wire slot 44 of the bracket 14. Thus, in addition to the physical registration between the registration features and the pad 16, the registration features can provide the orthodontist with a visual confirmation that the desired bracket positioning has been achieved. In an embodiment, although not depicted a gingival edge 45 of the guide tray 30 only extends gingivally even with the lateral registration features 40. This reduces the tooth surface 48 covered by the guide tray 30, which facilitates orthodontist access for cleaning excess bonding material and removal of the guide tray 30 after use. In still further embodiments, the lateral registration features 40 may be positioned further in the occlusal direction, and the gingival edge 45 adjusted occlusally as well to further reduce the size of the guide tray 30.

As noted above, embodiments as disclosed herein, provide the registration and definition of the desired bracket placement on the tooth while also facilitating orthodontists access to the opening 32 both in the direction towards the tooth surface through the opening 32, as well as due to the lack of a gingival side to the opening 32 provided by the guide tray 30. This facilitates both orthodontist access in order to place the bracket pad in registration with the registration features 38, 40 as well as facilitates removal of the guide tray 30 without placing undue forces on the bracket or pad while the adhesive or cement may still be curing and not at maximum strength.

As seen in FIG. 4, the guide tray extends in a thickness between the tray surface 50 and an outer surface 51. As depicted in FIG. 4, in an embodiment, this thickness may be exemplarily equivalent to a thickness of the bracket pad 16 over the tooth surface 48. In other embodiments, this thickness may be greater than or less than the bracket pad 16. In still further embodiments, the outer surface 51 may exemplarily correspond to the shape of the tray surface 50 such that the guide tray 30 is a consistent thickness. In other embodiments, the guide tray 30 may comprise varying thicknesses such that the outer surface 51 is different than the tray surface 50. Exemplarily, the outer surface may be generally flat or curved across portions of the guide tray 30 and tray sections 26. Exemplarily, the outer surface 51 is generally flat across an occlusal portion 63, lingual portion 61, and/or labial portion 65.

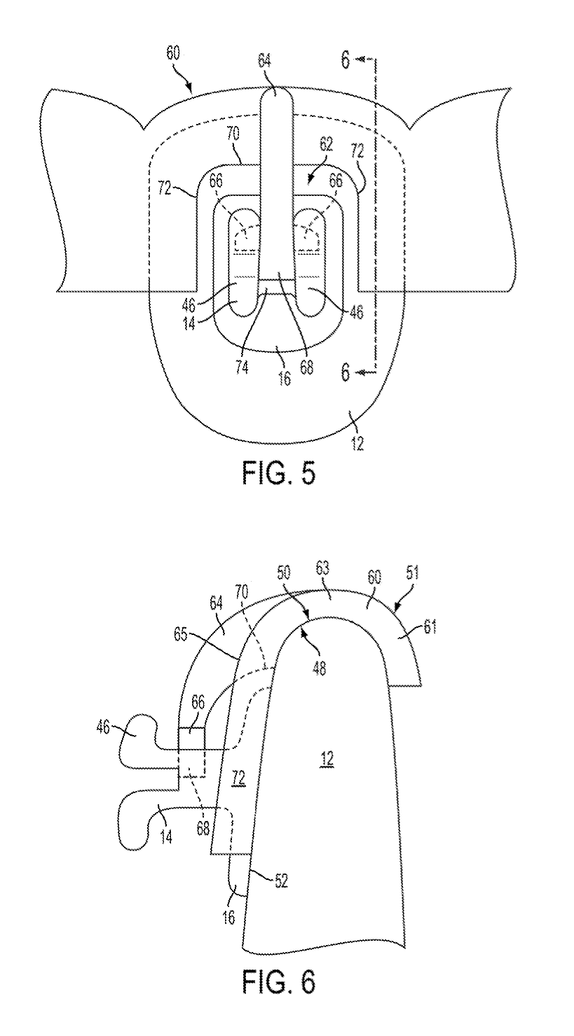

FIGS. 5 and 6 depict a still further embodiment of a portion of a guide tray 60. FIG. 6 is a cut away side view of the guide tray 60 of FIG. 5 taken along line 6-6. As is best depicted in FIG. 6, the guide tray 60 for a vestibular bracket placement includes a lingual portion 61, an occlusal portion 63, and a labial portion 65. Each of the lingual portion 61, occlusal portion 63, and labial portion 65 comprises an associated part of the tray surface 50, which is designed to correspond to the tooth surface 48. While in some embodiments, the exterior of the tray 60 may have similarities to the underlying tooth surface 48, in still other embodiments, the exterior sides of the lingual portion 61, occlusal portion 63 and labial portion 65 may have an alternative geometry. In a still further embodiment one or both of the lingual portion 61 and labial portion 65 may be reduced or eliminated, particularly in embodiments wherein a registration feature extends from the occlusal portion 63. In some such embodiments, the opening may be the area of the tooth gingivally of the gingival edge 45 of the guide tray 60. The guide tray 60 includes an opening 62 that generally defines the desired bracket location on a tooth 12 of the patient. However, the opening 62 is dimensioned such that each of the occlusal side 70 and lateral sides 72 are not in contact with the bracket pad 16 when the pad 16 and bracket 14 are secured at the desired location. Thus, the opening 62 defines an open space entirely around the perimeter of the pad 16 which facilitates orthodontist cleanup of any extraneous bonding cement or adhesive.

The guide tray 60 defines the desired position of the bracket 16 on the tooth 12 of the patient with a registration arm 64 that extends outwardly from the guide tray 60 in a direction away from the tooth surface 48 to which the bracket pad 16 is to be secured. The registration arm 64 extends away from the guide tray 60 before extending into the interior of the opening 62 such as to maintain orthodontist access to the opening 62 to facilitate placement of the bracket on the tooth 12 of the patient. The registration arm 64 may include at least one registration feature, which may exemplarily include horizontally extending vertical registration features 66 and vertically extending horizontal registration features 68. The vertical registration features 66 define a vertical position of the bracket on the tooth 12 in the occlusal-gingival direction by abutting against a portion of the bracket 14 when that potion of the bracket 14 reaches the desired vertical position for that feature. The horizontal registration feature 68, engages the bracket 14, exemplarily in a slot 74 between generally opposed tie wings 46. The engagement between the slot 74 and the horizontal registration feature 68 ensures that the bracket 14 is positioned in a desired horizontal placement on the tooth 12. In additional embodiments, one or more of the registration features, including but not limited to horizontal registration features or vertical registration features, may be configured to engage one or more other portions of the bracket, including, but not limited to, the tie wing or wings and the arch wire slot.

It will be recognized that in alternative embodiments, combinations of the embodiments as disclosed above may be used, exemplarily to include a registration arm 64 (FIG. 5) in conjunction with one or more of the occlusal registrations features 38 or lateral registration features 40 (FIG. 3) such as to define the desired bracket position on the patient's tooth 12. It will be recognized however, that in any such embodiment, the opening remains free to the gingival direction such that placement of the bracket 14 and pad 16 by the orthodontist is unobstructed until the bracket and/or pad engages one or more of the registration features as disclosed herein.

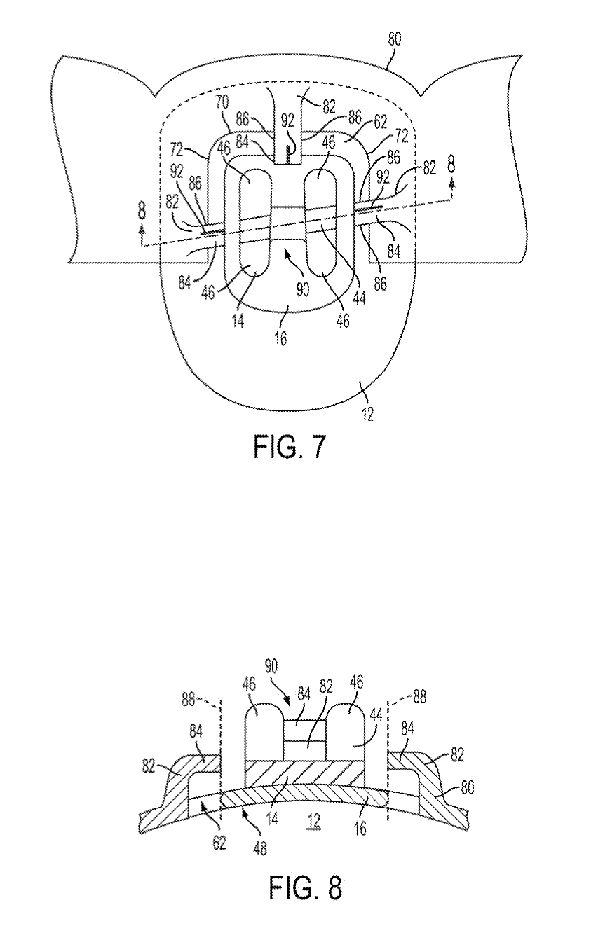

FIGS. 7 and 8 depicts a still further embodiment of a portion of a guide tray 80. FIG. 8 is a cut away view of the guide tray 80 of FIG. 7 taken along line 8-8. The guide tray 80 includes and opening 62 that generally defines the desired bracket location on a tooth 12 of the patient. However, the opening 62 is dimensioned such that each of the occlusal side 70 and lateral sides 72 are not in contact with the bracket pad 16 when the pad 16 and the bracket 14 are secured at the desired location on the patient's tooth 12. Thus, the opening 62 defines an open space entirely around the perimeter of the bracket pad 16 which facilitates orthodontist cleaning up of any extraneous bonding cement or adhesive.

The guide tray 80 assists the orthodontist in placement of the bracket on the tooth of the patient at the desired position with at least one alignment arm 82. The alignment arm 82 extends outwardly from the guide tray 60 in a direction away from the tooth surface 48 to which the bracket pad 16 was to be secured. The alignment arm 82 extends away from the guide tray 80 before extending into the interior of the opening 62. However, differing from previous embodiments, the alignment arms 82 do not contact the bracket 14 or bracket pads 16 but rather are dimensioned and/or positioned in order to align with features of the bracket when properly placed on the tooth of the patient at the desired location.

As can exemplarily be seen in FIG. 7, the alignment arms 82 that extend from the lateral sides 72 of the opening 62 each end in an alignment tip 84 that is configured to align with the arch wire slot 44 of the bracket 14. In the exemplary embodiment of FIGS. 7 and 8, the arch wire slot 44 is configured to impart an angulation on the tooth; however, it will be recognized that in alternative embodiments of brackets 14 as used exemplarily herein, the arch wire slot 44 may include no angulation. It will be noted that in the embodiment depicted in FIGS. 7 and 8, the alignment arms 82 that extend from the lateral side 72 are similarly angled such that the opposed sides 86 of the alignment arm are parallel with the side walls of the arch wire slot 44 and the alignment arms 82 themselves are also angled, such that the alignment arms 82 and the opposed sides 86 are in visual alignment with the arch wire slot 44. This provides a visual guide for the orthodontist to place the bracket at the desired position on the patient's tooth. As is best seen in FIG. 8, the alignment tips 84 of the alignment arms 82 extend from the lateral sides 72. In an embodiment, the alignment tips 84 terminate at a position denoted by reference lines 88 that are in alignment with the edges of the bracket pad 16. Thus, in such embodiments, the alignment arms 82 provide a further visual queue that the bracket has been placed at the proper location on the patient's tooth.

In an alternative embodiment, exemplarily depicted by the alignment arm 82 extending from the occlusal side 70, the alignment tip 84 may extend beyond the edge of the bracket pad (as best depicted in FIG. 7) such that the alignment tip 84 is in closer proximity to a reference structure on the bracket 14 in this embodiment, the space 90 between the tie wing 46. Similar to the other embodiment, the opposed sides 86 of the alignment arm 82 are dimensioned such that they are in parallel to an alignment with the reference structure on the bracket 14, namely, the space 90 between the tie wings 46. It will be recognized that the alignment tip 84 may be sized, oriented and/or dimensioned to relate to another reference structure on the bracket, including, but not limited to a tie wing or a clip of a self-ligating bracket (not depicted). The alignment of the alignment tip within the space 90 can be seen in FIG. 8. In still further embodiments, the alignment tip 84 may further include a visual reference 92 that further denotes a midline of the alignment arm 82 such as to provide a still further visual cue to the orthodontist in accurate placement of the bracket 14 and pad 16.

In these exemplary embodiments, reference and guidance is provided to the orthodontist to facilitate the proper placement of the bracket on the patient's teeth according to the desired prescription. As no portion of the guide physically touches the bracket 14 and particularly the bracket pad 16, the orthodontist maintains access to the entire opening 62 to facilitate the clean-up of any extraneous bonding cement or adhesive. Furthermore, because the guide 80 is open in the gingival direction, the alignment tips 84 are distanced away from the tooth surface 48, and the alignment tips 84 minimally extend beyond the perimeter of the bracket pad, if any, the orthodontists has improved access to the opening 62 to facilitate placement of the bracket on the patient's tooth with little or no interference from the alignment arms 82. Even in embodiments wherein a portion of one or more of alignment tips 84 extend past a perimeter of the bracket pad 16, as the opening 62 is opened to gingival direction and the alignment tips 84 are spaced apart from the other surface 48, the bracket and bracket pad can be easily positioned on the tooth of the patient after the guide tray 8—has been secured to the patient's teeth.

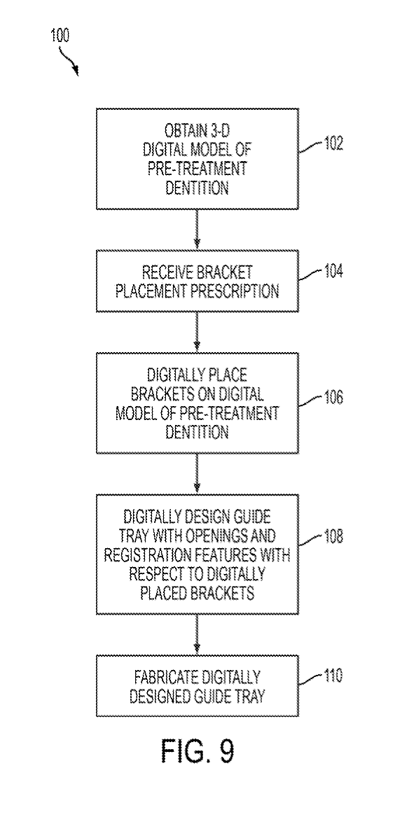

FIG. 9 is a flow chart that depicts an exemplary embodiment of a method 100 of manufacturing a guide tray as disclosed in the present application.

At 102, a 3D digital model of the patient's pre-treatment dentition is obtained. In exemplary embodiments, the 3D digital model may be obtained from a digital scan of the patient's mouth or may be obtained by scanning a cast impression or physical model of the patient's teeth. The 3D digital model may be obtained in a variety of ways including, but not limited to medical imaging techniques such as computed tomography (CT), by creating a plaster cast of the patient's dentition and digitally scanning the cast, or by intraoral scanning.

This results in a 3-dimensional digital model of the patient's pre-treatment dentition. In some embodiments, as described in further detail herein, the digital design of the bonding guide may be performed using this digital model of the pre-treatment dentition. In still other embodiments, a digital set up may be created to digitally create a model of the desired post-treatment dentition of the patient.

In doing so, the pre-treatment digital model is manipulated to segment the individual teeth with in the 3D digital model. The separated teeth are digitally repositioned to reflect the desired post-treatment positions of the patient's teeth. Each of the transformations required to digitally reposition the separated teeth are recorded and saved. This creates both a record of the originally pre-treatment dentition and the transformation required by the treatment to arrive at the desired post-treatment dentition. Once the teeth have been repositioned into the post-treatment position, an arch wire lane may be positioned on the teeth and idealized bracket placements calculated therefrom. In a digital setup, once the bracket placements have been determined, the post treatment dentition is transformed back to the current pre-treatment positions of the teeth with the placed bracket. These determined bracket placements may be used in the creation of the bonding guide as disclosed herein.

In other embodiments, as found at 104, a bracket placement prescription is received. In an embodiment, the orthodontist may identify a particular prescription to be followed in determining the desired bracket placements. In non-limiting examples of commonly used prescriptions may include Roth, MBT, or Andrews prescriptions although other prescription theory and techniques will be recognized by those of ordinary skill in the art. Alternatively, the bracket placement prescription can be defined as placement relative to anatomical landmarks, exemplarily as linear distances or angles with respect to anatomical landmarks such as cusp tips, incisal edges, gingival margins, etc. The bracket placement prescription may further include an identification of whether the brackets are to be placed vestibularly or lingually.

In embodiments wherein the orthodontist provides a bracket placement prescription, if a predefined prescription, for example, a Roth, MBT, or Andrews prescription is identified, then digital version of bracket designed according to the selected prescription are selected, exemplarily from a library of digitized brackets and positioned on the teeth of the patient. Brackets in accordance with a prescription such as a Roth, MBT, or Andrews prescription may be deigned to include the tooth tilt, tip, and torque associated with that prescription, which may result in a configuration of bracket, and arch wire slot particular to that prescription. Still further, each prescription may also include a generalized preferred placement in the patient's teeth. This can be stored and used by the computer system to digitally place the selected bracket at the predefined location. As previously mentioned, in alternative embodiments, the orthodontist may specify a particular placement position on the teeth for the brackets and/or may further select the specific brackets to be used in connection with the bracket placements.

Digital models of the brackets and bracket pads to be used in the orthodontic treatment are digitally placed on the digital model of the patient's pre-treatment dentition at 106 according to the bracket placement prescription received at 104. This placement may occur in either of the manners as disclosed above, including the digital set-up and the digital application of an orthodontist prescription. Alternatively, a technician may digitally position the brackets manually. In a non-limiting embodiment, a user may be provided with the functionality to review and adjust the digital bracket placements prior to finalizing the digital placement of the brackets on the digital model of the patient's pre-treatment dentition. In one such embodiment, the digital brackets may be repositioned interactively, such as with drag and drop inputs or may be repositioned by adjusting the selected bracket or bracket placement prescription.

At 108 a guide tray is digitally designed on the pre-treatment model such that it conforms to the shape of the occlusal tooth surface and conforms to at least a portion of the lingual and labial tooth surfaces. The guide tray is digitally designed with opening and registration features as disclosed in the present application with respect to the digitally placed brackets on the digital model. In one embodiment, the guide tray is designed by defining a guide tray thickness that is consistent across the entire designed guide tray. This thickness is extended outwardly from the tooth surfaces of the digital model of the patient's pre-treatment dentition at directions perpendicular to the tooth surface. In one embodiment, the guide tray thickness is the same thickness as the pads digitally placed on the digital model, while in alternative embodiments, the guide tray thickness may be greater than or less than the pad thickness. As described above, the guide tray may be digitally designed such that brackets can be positioned lingually or labially or a combination of both bracket placements. Furthermore, the guide tray may be digitally designed at 108 such as to include a plurality of separation features, including, but not limited to perforations, perforations such that the guide tray may be separated into a plurality of smaller tooth segments.

The opening and registration features of the guide tray are digitally designed around the placed brackets. As described above, the opening is configured about the bracket pad such that the opening is generally larger than the bracket pad itself. The registration features are then designed relative to each of the place digital brackets so that the registration features of the bonding guide are specific to the selected bracket and the placement of the bracket on the patient's tooth. The registration features include any of the registration features as disclosed in the presented application, or a combination thereof. By digitally designing the openings and the registration features of the guide tray relative to the position digital brackets, the guide tray is customized to the pre-treatment dentition of the patient and the prescription provided by the orthodontist.

At 110, the digitally designed guide tray is fabricated. In embodiments, the guide tray may be fabricated using rapid prototyping, 3D printing, or CNC milling techniques, although other fabrication techniques may also be used to create the digitally designed guide tray.

In an embodiment, the fabricated guide tray may be used to assist a direct bonding placement of brackets on a patient's teeth by an orthodontist by further securing the guide tray to the patient's teeth and then placing each of the individual brackets and/or bracket pads in registration with one or more registration features of the guide tray to ensure that the bracket and bracket pads are in the desired position on the patient's tooth. Alternatively, the guide tray, once fabricated may be secured to a physical model of the patient's pre-treatment dentition, exemplarily the same physical model of the patient's pre-treatment dentition used at 102 in order to obtain the 3D digital model. Once the guide tray is secured to the physical model of the patient's pre-treatment dentition, the guide tray is used to place the brackets at the desired bracket locations and an indirect bonding tray may be formed over the physical model of the patient pre-treatment detention and the placed brackets. The indirect bonding tray may then be used by an orthodontist to place the brackets on the patient's teeth.

Embodiments of the apparatus and methods as disclosed herein enable the accurate transfer of digitally determined bracket placement positions to the physical world while providing improved visibility and accessibility to each bracket during the bonding process. This enables orthodontist's verification of proper bonding and facilitates cleanup of any extraneous bonding cement or adhesive before or after curing of the bonding cement or adhesive. In embodiments, wherein perforations separate the guide tray into a plurality of tooth segments, individual tooth segments may be used to facilitate the re-bonding or replacement of brackets that become detached from the dentition or must be replaced prior to completion of the orthodontic treatment.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An orthodontic guide tray, comprising:
a tray surface at least partially congruent with a respective occlusal tooth surface, lingual tooth surface, and occlusal tooth surface;
at least one opening through the tray surface, the at least one opening defined by an occlusal side and generally opposed lateral sides and open in a gingival direction, wherein the at least one opening is configured to be larger in a mesial-distal dimension and occlusal-gingival dimension than a pad of a bracket to be placed on a tooth through the opening;
lateral registration features that extend in the labial direction from the tray surface and then extend from the respective lateral sides interior the opening and define a prescribed bracket placement in the mesial-distal dimension by visual alignment between the lateral registration features and the bracket, the lateral registration features free from engagement with the bracket.

2. The orthodontic guide tray of claim 1, further comprising:
a plurality of openings through the tray surface, the plurality of openings comprising the at least one opening.

3. The orthodontic guide tray of claim 1, wherein lateral registration features further each comprise an arm tip, the arm tip configured to visually align with an edge of a bracket pad of the bracket to define the prescribed bracket placement in the mesial-distal dimension, and the lateral registration features further visually align with an arch wire slot of the bracket to define the prescribed bracket placement in the occlusal-gingival dimension.

4. The orthodontic guide tray of claim 1, further comprising at least one occlusal registration feature that extends in the labial direction from the tray surface and then extends from the occlusal side interior the opening and defines the prescribed bracket placement on the tooth in the occlusal-gingival dimension by visual alignment, the at least one occlusal registration feature free from engagement with the bracket.

5. The orthodontic guide tray of claim 4, wherein the prescribed bracket placement on the tooth is unobstructed by the tray surface, the occlusal registration feature, and the lateral registration features.

6. (canceled)

7. The orthodontic guide tray of claim 4, wherein the occlusal registration feature is configured to align with a predetermined portion of the bracket when the bracket is positioned at the prescribed bracket placement on the tooth.

8. The orthodontic guide tray of claim 4, wherein the registration features further comprises visual alignment indicators.

9. The orthodontic guide tray of claim 8, wherein the visual alignment indicator of the occlusal registration feature further defines a mesial-distal midline of the occlusal registration feature to define the prescribed bracket placement on the tooth in the mesial-distal dimension.

10. An orthodontic guide tray including a plurality of tooth segments, each of the tooth segments, comprising:
an occlusal portion with a tray surface corresponding to an occlusal surface of a tooth of a patient;
a lingual portion with a tray surface corresponding to a lingual surface of the tooth;
a labial portion with a tray surface corresponding to a labial surface of the tooth;
an opening in the labial portion defined by an occlusal side and generally opposed lateral sides, the opening generally larger than a bracket pad of a bracket configured to be adhered to a tooth of the patient through the opening;
an occlusal alignment arm that extends in the labial direction from the tray surface and then extends into the opening from the occlusal side, the occlusal alignment arm defines a previously determined bracket placement on the tooth in an occlusal-gingival dimension, the occlusal alignment arm free from engagement with the bracket; and
lateral alignment arms that extend in the labial direction from the tray surface and then extend into the opening from the respective lateral sides, the lateral alignment arms define a previously determined bracket placement on the tooth in the mesial-distal dimension, the lateral alignment arms free from engagement with the bracket.

11. The orthodontic guide tray of claim 10, wherein the occlusal alignment arm comprises an arm tip that visually aligns with an occlusal edge of the bracket pad to define the previously determined bracket placement in the occlusal-gingival dimension and the lateral alignment arms comprise arm tips that respectively visually align with lateral edges of the bracket pad to define the previously determined bracket placement in the mesial-distal dimension.

12. The orthodontic guide tray of claim 10, wherein a width of the lateral alignment arms corresponds to a width of an arch wire slot of the bracket and the lateral alignment arms visually align with the arch wire slot to define the previously determined bracket placement in the occlusal-gingival dimension.

13-14. (canceled)

15. The orthodontic guide tray of claim 10, wherein the predetermined bracket placement on the tooth is unobstructed by the labial portion, the occlusal alignment arm, and the lateral alignment arms.

16. (canceled)

17. The orthodontic guide tray of claim 10, wherein each tooth segment of the plurality of tooth segments is separable from an adjacent tooth segment of the plurality of tooth segments.

18. The orthodontic guide tray of claim 17, wherein each tooth segment of the plurality of tooth segments is separated from the adjacent tooth segment by a plurality of perforations.

19. An orthodontic system comprising:
a plurality of brackets each configured to be secured at a predetermined location on a tooth of a patient;
a guide tray including a plurality of tooth segments, each of the tooth segments, comprising:
an occlusal portion with an occlusal tray surface corresponding to an occlusal surface of a tooth of a patient;
a lingual portion with a lingual tray surface corresponding to a lingual surface of the tooth;
a labial portion with a labial tray surface corresponding to a labial surface of the tooth;
an opening in the labial portion defined by an occlusal side and generally opposed lateral sides, the opening generally larger than a bracket pad of a bracket of the plurality of brackets configured to be adhered to the tooth through the opening; and
an occlusal alignment arm that extends in the labial direction from the tray surface and then extends into the opening from the occlusal side, the occlusal alignment arm defines a previously determined bracket placement on the tooth in an occlusal-gingival dimension; and
lateral alignment arms that extend in the labial direction from the tray surface and then extend into the opening from the respective lateral sides, the lateral alignment arms define a previously determined bracket placement on the tooth in the mesial-distal dimension.

20. The system of claim 19, wherein the occlusal alignment arm comprises an arm tip that visually aligns with an occlusal edge the bracket pad to define the previously determined bracket placement in the occlusal-gingival dimension and the alteral alignment arms comprise arm tips that respectively visually align with lateral edges of the bracket pad to define the previously determined bracket placement in the mesial-distal dimension.
